(19) United States
(12) Patent Application Publication
(10) Pub. No.: US 2006/0202847 A1
(43) Pub. Date: Sep. 14, 2006

(54) Smoke detector

(76) Inventors: Ulrich Oppelt, Zorneding (DE); Bernd Siber, Glonn (DE)

Correspondence Address: KENYON & KENYON LLP, ONE BROADWAY, NEW YORK, NY, 10004, US

(21) Appl. No.: 10/530,318

(22) PCT Filed: Sep. 15, 2003
(86) PCT No.: PCT/DE03/03062

§ 371 Date: Apr. 20, 2006

(30) Foreign Application Priority Data
Oct. 2, 2002 (DE) 102 46 056.6

(51) Int. Cl. G08B 17/10; G08B 23/00

(52) U.S. Cl. 340/630; 340/693.6

(57) ABSTRACT

A smoke detector that has an image sensor and a light source, and the image sensor can sense smoke at a close distance, and the light source can be activated if there is insufficient ambient light for the image sensor.

### FIELD OF THE INVENTION

The present invention relates to a smoke detector.

### BACKGROUND INFORMATION

German Published Patent Application No. 100 11 411 describes a smoke detector that is implemented utilizing a video camera or infrared camera. This may provide for a light source having a suitable wavelength range that is provided for the image sensor, since the particle size of the smoke particles is detected via the scattering of light on these smoke particles, whereby a corona is formed around the defined light source.

### SUMMARY OF THE INVENTION

The smoke detector according to the present invention has advantages over the above art in that the image sensor, which is located in the smoke detector, is configured to monitor an area very close to the smoke detector, and the light source is controllable in such a way that the light source is able to be activated when there is insufficient ambient light for the image sensor.

It is particularly advantageous that the smoke detector is configured in such a way that, based on a signal from the image sensor, the smoke detector detects the intensity of the ambient light. In this way it is possible to activate the light source as soon as the ambient light is insufficient based on the analysis of the signal from the image sensor. The analysis of the signal from the image sensor is performed by a processor that possesses the algorithms that are customarily used for image analysis.

Alternatively, it is possible to provide an additional ambient light sensor, a photodiode for example, to measure the intensity of the ambient light. The light source is then activated as a function of this signal.

A further advantage is that the image sensor is configured to observe smoke at a distance of from 5 to 20 cm. These 5 to 20 cm define what is here considered to be a close distance. In this way in particular it is possible to replace the function of a conventional scattered-light smoke detector by the smoke detector of the invention, which likewise only senses the immediate vicinity.

It is also advantageous that the image sensor is disposed in a labyrinth. Here the similarity with a scattered-light smoke detector becomes apparent. Normally, a light source and a photodiode are disposed in the labyrinth in order to detect light scattered by the smoke. In the present invention, an image sensor is used to directly detect the image of the penetrating air or smoke. The light source is then used for the purpose of illumination. The light source may preferably be a light-emitting diode. This is an advantageous embodiment, one that is also possible, for example, as a white light-emitting diode.

For practical and aesthetic reasons the smoke detector may be mounted flush with the surface of a wall or a ceiling. In this way, the detector does not project into the room and therefore does not inhibit movement in the room. In addition, this allows the detector to be installed in an unobtrusive manner in rooms in which a smoke detector should be as inconspicuous as possible.

The image sensor may preferably be embodied as a miniature camera. Such cameras, for example those utilizing CMOS technology, are available at economical prices.

The image sensor may be advantageously mounted in such a way that its field of view may be aimed downward or at an angle to the side from the detector cover. This allows the immediate environment to be observed in an optimal manner. The optical system is set in such a way that the focal point is located about 10 cm below the cover. This is the distance at which smoke is to be expected in the event of a fire and where, because of the proximity to the ceiling, no objects are to be expected. Due to the proximal focal point, the visible background is represented out-of-focus. If smoke is rising from a fire, however, the image that is produced in the vicinity of the image sensor is sharp because of the optical settings. The image of smoke from a fire will differ significantly from the background because of the image sharpness of the brightness distribution, of the movement of the swirls of smoke, and of the of contour formation. Suitable image processing routines may be utilized to discriminate between smoke and background.

In contrast to a scattered-light smoke detector, which measures the intensity of the scattered light coming from a specifically activated light source, in the present invention, the smoke is detected via properties present in the image. Filters or geometric measurement chambers used to block out the effects of surrounding light sources are not required; they are automatically used to make the smoke visible. Therefore, the apparatus is completely independent of extraneous light. Moreover, the extremely high information content provided by an image sensor allows additional information to be derived from the image signal. Insects, spiders, moths present on the surface of the detector cover may be classified on the basis of their image sizes and structures and therefore differentiated from smoke. Objects that come into the more in-focus measurement range of the detector, for example ladders, cabinets, or stacks of boxes, are sharply imaged; they have a markedly different structure from smoke, and they may therefore be blocked out, and an error message concerning the now limited function range is able to be generated. Dust and dirt on the cover plate exhibit significant differences compared with a reference image without dust and dirt, so that a gradual buildup of dust and dirt is able to be detected. If the detector is completely covered or painted over, significant image changes also occur, and may cause an error message to be generated. In order to function properly, the image sensor requires a certain ambient brightness, although because of the control response it is largely independent of the actual brightness. The signal processing system is able to react to an intentional blocking (overriding) of the image sensor, issuing an error message. In the event of total darkness or insufficient light for the image sensor to function properly, for example in the case of operation in basements or at night, a pointedly controlled light source is used with scattered-light smoke detectors. In the event of darkness, this light source is sufficient to illuminate the smoke from a fire, so that the image sensor receives the corresponding image.

### BRIEF DESCRIPTION OF THE DRAWINGS

FIG. 1 shows a first schematic diagram of the smoke detector according to the invention.

FIG. 2 shows a first configuration of the smoke according to the invention.

FIG. 3 shows a second configuration of the smoke detector according to the invention

FIG. 4 shows a flowchart on the analysis of the images.

FIG. 5 shows image analysis by changing the spatial frequency.

FIG. 6 shows an image analysis of the brightness distribution as a histogram of a structure having only two brightness values.

FIG. 7 shows a histogram of a structure having only two brightness values, where the structure has smoke superimposed on it.

### DETAILED DESCRIPTION

Today, the detection of smoke is one of the most reliable methods of detecting fires at an early point in time. Primarily punctiform detectors that function based on the principle of scattered light are used to detect smoke. These detectors utilize a measurement chamber having labyrinthine smoke inlet openings in order to exclude the effect of ambient light when measuring the very small measurement signals. The theoretical structure of a labyrinth as a measurement chamber has the disadvantage that small insects or, on the other hand, dust that has entered the measurement chamber, may appear as deceptive phenomena. In addition, the installation location of the measurement chamber must be a certain distance from the ceiling so that smoke is able to enter the measurement chamber. This results in units that are visibly mounted on the ceiling, something that often is not desirable in environments where aesthetic appearance is important. However, ambient light-type detectors that have an open arrangement of the paths of the light beams and do not use a surrounding measurement chamber are also known. This results in a unit that is able to be integrated into the environment in an unobtrusive manner, thereby meeting requirements for high aesthetic appeal, especially in representative environments. The advantage of installation flush with the ceiling comes at the expense of the now unhindered effect of ambient light due to the elimination of the optical measurement chamber. The effect of light is suppressed by electrical filtering, which differentiates between extraneous light and that which is emitted by the unit itself for measuring the smoke diffusion. However, electronic filtering results in a relatively high electronic complexity, and in order for the filter to be highly efficient, a relatively large amount of energy for a fire detector must be used. In addition, the monitoring of the surface of such a detector to detect the presence of high levels of dust and dirt or to detect being painted over is not possible without additional methods.

Therefore the present invention proposes a smoke detector having an image sensor and a light source that avoids these disadvantages. Based on the development of semiconductors, CMOS image sensors that output digital image information that may be processed by an image processor are available. Both the image sensor and the processor are available in miniaturized form, so that such an arrangement may be disposed in a detector housing without difficulty. Such an image sensor may be used with wide ranges of exposure times, so that it is able to work under widly varying brightness conditions. Certain types of image sensors are known that have in addition to this an extremely high dynamic range of more than 120 dB of the brightness information, and are therefore even able to function in environments that have a high level of contrast.

The main advantages of the invention are therefore
insensitivity to extraneous light
detection of dust and dirt present in the image contents
differentiation among insects, objects, and smoke via image analysis
detection of smoke at a reasonable distance from the ceiling by selecting an appropriate focal point
detection of covering or painting over
self-monitoring by monitoring the image signal for expected image contents
use of the high information content provided by an image sensor
use of the signal-processing methods of image analysis.

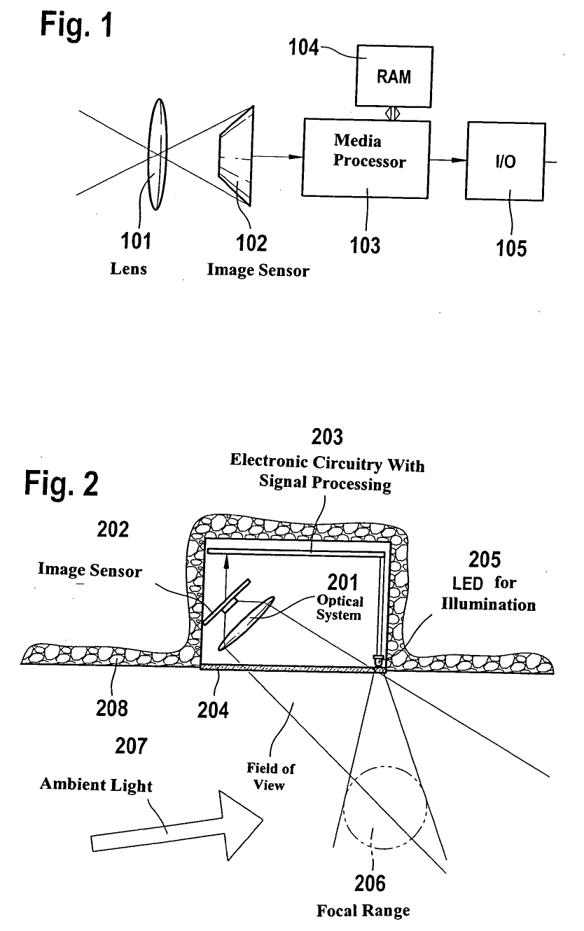

FIG. 1 shows a schematic diagram of the smoke detector of the invention. As an optical system, the smoke detector has a lens 101 that adjusts the focus for an image sensor 102. Typically, the focus is set to 10 cm. Thus, background images are blurry compared to images from the immediate vicinity. Image sensor 102 transmits the image signal to a media processor 103, for example to an analog input, and media processor 103 then performs the analog-digital conversion using its own analog-digital converter. Alternatively, it is possible for media processor 103 to receive the image signal via a digital input and thus be able to process it further immediately. The analysis of the image is performed by media processor 103 using a memory 104, typical image analysis algorithms being used. In this process, media processor 103 searches for images of smoke, but also for slow changes, media processor 103 using reference images for this purpose. These slow changes indicate increasing soiling and may thus result in the generation of an error message. In addition, insects or other objects that enter the detection area of image sensor 102 are able to be recognized via image analysis by processor 103. In the event of such an error message, or if smoke is detected, this message is communicated via an output module 105. This message may then be communicated to signaling means such as a siren or a light, or it may be communicated to a control center, which then initiates actions depending on the message.

FIG. 2 shows a first configuration of the smoke detector according to the present invention. The smoke detector is located in the rough plaster in a ceiling 208. A transparent cover 204 protects the interior workings of the smoke detector. Cover 204 is transparent so that it is possible for the smoke detector to observe the immediate vicinity. This cover 204 may also be eliminated in certain circumstances. Again, an optical system 201 is provided to set a focal range 206. An image sensor 202 is located behind optical system 201 so that it is able to sense the images in focal range 206. The image signal is transmitted to an electronic signal processor 203, typically media processor 103. The image signal is then analyzed there. The electronic circuitry 203 is also connected via an output to an LED 205 for illumination. If an ambient light 207 is too weak, the LED is activated by electronic circuitry 203 in order to provide adequate illumination in the observation field—in other words, in focal range 206. Normally, white light is used for this purpose. However, it is also possible to configure LED 205 as an infrared LED in order to provide the illumination in the invisible infrared range. In this case, image sensor 202 is then configured for sensing infrared. Here image sensor 202 and optical system 201 are disposed at an angle, this inclined arrangement being purely related to the practical reasons for the individual arrangement.

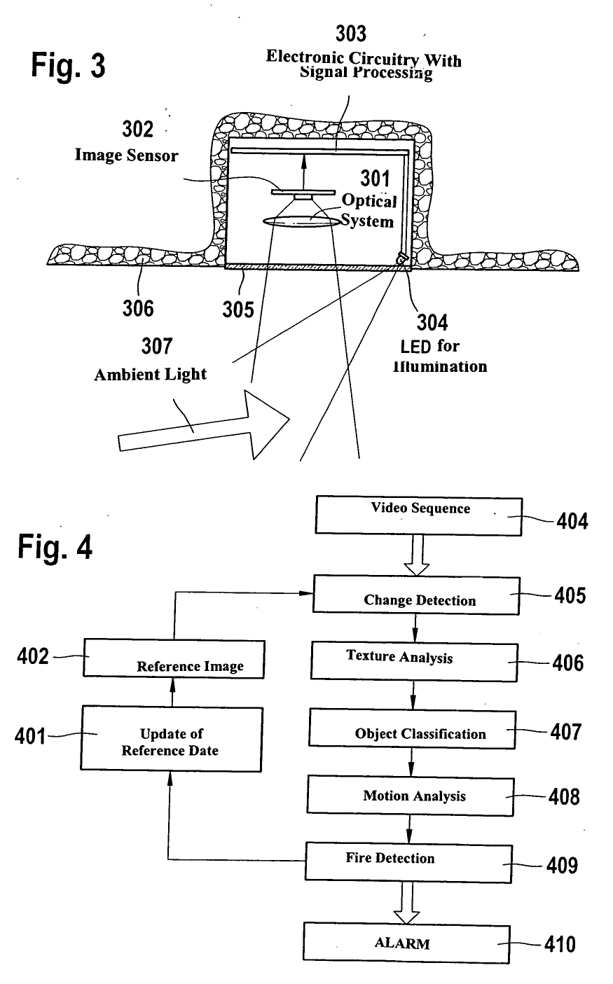

FIG. 3 shows a second configuration of the smoke detector according to the present invention. Once again, the smoke detector is mounted in the rough plaster in a ceiling 306 and has a transparent cover 305. Now, however, an optical system 301 with image sensor 302 are aimed vertically downward, an LED 304 that is used for illumination purposes then being mounted at an angle. Image sensor 302 is again connected to an electronic circuitry equipped with a signal processing system 303 that analyzes the image and that activates LED 304. Once again, LED 304 is activated by electronic circuitry 303 depending on ambient light 307. The arrangement now faces vertically downward, which permits the smoke detector of the invention to be installed and manufactured easily. Instead of one LED 304, it is also possible to use a plurality of LEDs. Instead of the image signal from image sensor 302 being analyzed to monitor brightness, it is also possible to provide a brightness sensor, for example a photodiode. Alternatively, it is also possible to mount the apparatus including optical system 301 and image sensor 302 so that it is able to pivot. This permits scanning, for example. This may also be accomplished using an electrical motor.

The flowchart in FIG. 4 shows the process flow for the image analysis that occurs in processor 103 or electronic circuitry 203 or 303. A video or image sequence 404 is first sent to a change detection function 405, which compares the registered image or video sequence with a reference image 402. In this way it is possible to determine whether or not a change has occurred. Texture analysis 406 checks structures present in areas of the image. The structure may be used, for example, to differentiate among the surface structure of objects that are brought into the viewing range, or the structure of the diffuse background, or the structure of smoke. By the detection of edges and hard structures, it also helps to ascertain the contours of objects or insects. With the aid of edges, the border of objects can be determined and, using object classification 407, conclusions can be drawn as to the type of object. If a change is present, the change may then be identified. If, for example, the change is of a slow, incremental nature, then there is reason to suspect the buildup of dirt and dust. Insects and other objects that are present directly in the focal range of the image sensor may also be identified in this way. Motion analysis 408 used in combination with object classification differentiates between movements of, for example, insects, or the movement of smoke flowing by the sensor, in order to detect the presence of a fire.

Depending on fire detection step 409, a message 410 is optionally output. In addition, an update of reference data 401 is performed following fire detection step 409. If, for example, the environment is changed by an object permanently introduced into the focal range, then this object must be taken into account in further observation in order to continue to ensure the basic function of the smoke detector—to detect the presence of smoke.

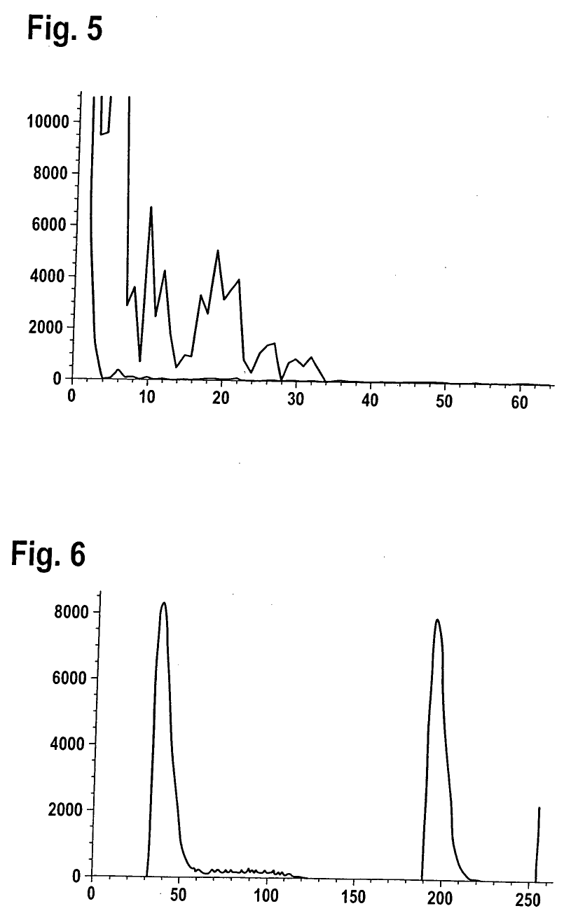

In FIG. 5, the analysis of an image through change in the spatial frequency is illustrated by a graph. Because of the occurrence of smoke, the edges that are present in the image become fuzzier, and therefore the high spatial frequencies are lost.

FIG. 6 shows the image analysis using a brightness distribution in the image. In order to illustrate clearly the effect caused by smoke, a histogram of a structure having only two brightness values is shown.

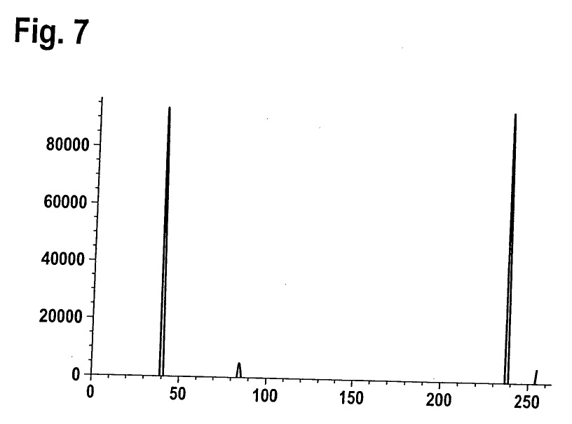

FIG. 7 shows the superimposing of smoke on the structure. The smoke is superimposed on the image structure, adding gray-value components. This results in a marked reduction of the frequency of the two brightness values, which previously were the only ones present. Because of the gray values of the smoke, moreover, the brightness values on the x-axis shift and the previously very steep flanks in the histogram are flattened out. This demonstrates how simple it is to perform smoke detection by image analysis.

In the event of interference, or if objects that the smoke detector itself senses as being disruptive to its functions are introduced, for example, a large object that causes the smoke detector to be covered so that the focal range can no longer be detected, an error message is generated. This can be communicated directly to a signaling means that is of an optical or acoustic type, or to a control center, so that the appropriate actions can be taken.

1.-11. (canceled)

12. A smoke detector, comprising:
an image sensor; and
a light source, wherein:
the image sensor records a presence of smoke at a close distance, and
the light source can be activated when ambient light is insufficient for the image sensor.

13. The smoke detector as recited in claim 12, wherein:
the smoke detector recognizes an intensity of the ambient light based on a signal from the image sensor.

14. The smoke detector as recited in claim 12, further comprising:
an ambient light sensor for measuring an intensity of the ambient light.

15. The smoke detector as recited in claim 12, wherein:
the image sensor is configured for monitoring at a distance of 5-20 cm.

16. The smoke detector as recited in claim 12, wherein:
the image sensor is disposed in a labyrinth.

17. The smoke detector as recited in claim 12, wherein:
the light source includes a light-emitting diode.

18. The smoke detector as recited in claim 12, further comprising:
an arrangement for mounting flush on one of a wall and a ceiling.

19. The smoke detector as recited in claim 12, wherein:
the image sensor includes a miniature camera.

20. The smoke detector as recited in claim 12, wherein:
a field of vision of the image sensor one of points downward and points at an angle toward a side from a detector cover.

21. The smoke detector as recited in claim 12, further comprising:
a cover; and
an optical system for focusing on a focal point about 10 cm on the cover.

22. The smoke detector as recited in claim 12, wherein:
the image sensor generates a reference image for subsequent comparisons at specified times.
